(19) United States
(12) Patent Application Publication
(10) Pub. No.: US 2025/0073864 A1
(43) Pub. Date: Mar. 6, 2025

(54) ADAPTOR FOR A TRAILER LIFT JACK

(71) Applicant: Conner Gough, West Branch, MI (US)

(72) Inventor: Conner Gough, West Branch, MI (US)

(21) Appl. No.: 18/816,356

(22) Filed: Aug. 27, 2024

Related U.S. Application Data
(60) Provisional application No. 63/535,111, filed on Aug. 29, 2023.

(51) Int. Cl. B25B 21/00; B25B 23/00; B60S 9/04

(52) U.S. Cl. CPC B25B 21/002; B25B 23/0035; B60S 9/04

(57) ABSTRACT

An adaptor for a trailer lift jack includes an elongated body extending in a longitudinal direction. The body has first and second opposite ends spaced from each other in the longitudinal direction. A sidewall extends between the first and second ends. The first end includes a bore extending into the body in the longitudinal direction. The second end is adapted to mate with a drive member. At least one pair of openings are formed in the sidewall. The openings of each pair extend from the sidewall to the bore. The openings of each pair are aligned with each other. The adaptor is disposable over an actuator shaft of a trailer lift jack such that the actuator shaft is received into the bore. The adaptor is secured to the actuator shaft by a fastener extending through one said pair of openings and a corresponding opening through the actuator shaft.

### CROSS REFERENCE TO RELATED APPLICATIONS

This application claims the benefit of U.S. Provisional Application No. 63/535,111, filed Aug. 29, 2023, the disclosure of which is incorporated by reference in its entirety.

### FIELD OF THE INVENTION

The disclosure generally relates to trailer lift jacks and, more specifically, to an adaptor for cranking an actuator shaft of a trailer lift jack.

### BACKGROUND OF THE INVENTION

A trailer lift jack raises and lowers a trailer such as an enclosed cargo trailer, a flatbed trailer, a vehicle trailer, a boat trailer, or other utility trailer so that the trailer may be hitched to or disconnected from a vehicle that is used to haul the trailer. Typically, the lift jack is actuated by manually turning a hand crank that is connected to the actuator shaft of the lift jack. Rotating the hand crank in one direction raises the lift jack while rotating it in the opposite direction lowers the lift jack. Rotating the hand crank, however, can be physically taxing and difficult depending on such factors as the distance in which the jack needs to be raised and lowered, the weight of the trailer, the quality and load capacity of the lift jack itself, the construction of the lift jack's hand crank, and the like. Therefore, a need exists for a device that allows for easy conversion of a manual, hand-powered trailer lift jack to a motor driven trailer lift jack, such as a device that allows a manual trailer lift jack to be raised and lowered with the simple use of a hand-held power tool.

### BRIEF SUMMARY OF THE INVENTION

An adaptor for a trailer lift jack is provided. The adaptor is intended to replace the handheld crank of a conventional lift jack, and can be affixed to the lift jack by a fastener such as a bolt or similar. The adaptor includes an elongated body extending in a longitudinal direction. The body has first and second opposite ends spaced from each other in the longitudinal direction. A sidewall extends between the first and second ends. The first end is adapted to receive an actuator shaft of a trailer lift jack and the second end is adapted to mate with a drive member. The first end includes a bore extending into the body in the longitudinal direction. At least one pair of openings are formed in the sidewall. The openings of each pair extend from the sidewall to the bore. The openings of each pair are aligned with each other. The adaptor is disposable over an outer end of the actuator shaft of the trailer lift jack such that the outer end of the actuator shaft is received into the bore. The adaptor is secured to the actuator shaft by a fastener extending through one said pair of openings and a corresponding opening through the actuator shaft.

In specific embodiments, the openings are transverse to the longitudinal direction.

In specific embodiments, the openings are perpendicular to the longitudinal direction.

In specific embodiments, the openings of each pair are disposed 180 degrees apart from each other radially around the sidewall.

In specific embodiments, the adaptor includes two pairs of said openings.

In particular embodiments, one said pair of openings is offset from the other said pair in the longitudinal direction.

In particular embodiments, one said pair of openings is offset from the other said pair in a circumferential direction.

In specific embodiments, each said opening has a circular cross-sectional shape.

In specific embodiments, the body is cylindrical in shape.

In specific embodiments, the bore has a circular cross-sectional shape.

In specific embodiments, the bore is centered along a longitudinal axis of the body that extends in the longitudinal direction.

In specific embodiments, the second end includes a receiver for receiving a male portion of a square drive.

In particular embodiments, the bore includes a taper at an inner end of the bore. The taper is connected to the receiver.

In specific embodiments, the second end of the body includes a head configured to mate with a wrench socket.

In particular embodiments, the head has a hexagonal cross-sectional shape.

A system for driving an actuator shaft of a trailer lift jack is also provided. The system includes an adaptor as described above. The system also includes a fastener and a drive. The adaptor is disposed over an outer end of the actuator shaft of the trailer lift jack such that the outer end of the actuator shaft is inserted into the bore. The fastener is inserted through one said pair of openings and a corresponding opening through the actuator shaft. The corresponding opening in the actuator shaft is aligned with the one said pair of openings. The second end of the adaptor includes a receiver for receiving the drive. The drive is mateable with the receiver, and operation of the drive actuates the actuator shaft.

In specific embodiments, the fastener is one of a bolt and a pin.

In specific embodiments, the drive is one of a drill and a wrench.

A method of driving an actuator shaft of a trailer lift jack is also provided. The method includes providing an adaptor as described above. The adaptor further includes a receiver for receiving a drive member. The method further includes disposing the adaptor over an outer end of the actuator shaft of the trailer lift jack such that the outer end of the actuator shaft is inserted into the bore. The method further includes inserting a fastener through one said pair of openings and a corresponding opening through the actuator shaft, the corresponding opening in the actuator shaft being aligned with the one said pair of openings. The method further includes mating the drive member with the receiver. The method further includes operating the drive to actuate the actuator shaft of the trailer lift jack.

### BRIEF DESCRIPTION OF THE DRAWINGS

Various advantages and aspects of this disclosure may be understood in view of the following detailed description when considered in connection with the accompanying drawings, wherein:

FIG. 1(a) is a perspective view of an adaptor for a trailer lift jack in accordance with a first embodiment of the disclosure;

FIG. 1(b) is a perspective view of the adaptor in accordance with the first embodiment, with hidden features shown in phantom line;

FIG. 1(c) is a cross-sectional view of the adaptor in accordance with the first embodiment;

FIG. 1(d) is another cross-sectional view of the adaptor in accordance with the first embodiment;

FIG. 1(e) is a plan view of a first end of the adaptor in accordance with the first embodiment;

FIG. 1(f) is a plan view of an opposite second end of the adaptor in accordance with the first embodiment;

FIG. 2(a) is a perspective view of an adaptor for a trailer lift jack in accordance with a second embodiment of the disclosure;

FIG. 2(b) is a perspective view of the adaptor in accordance with the second embodiment, with hidden features shown in phantom line;

FIG. 2(c) is a cross-sectional view of the adaptor in accordance with the second embodiment;

FIG. 2(d) is another cross-sectional view of the adaptor in accordance with the second embodiment;

FIG. 2(e) is a plan view of a first end of the adaptor in accordance with the second embodiment;

FIG. 2(f) is a plan view of an opposite second end of the adaptor in accordance with the second embodiment;

FIG. 3(a) is a perspective view of an adaptor for a trailer lift jack in accordance with a third embodiment of the disclosure;

FIG. 3(b) is a perspective view of the adaptor in accordance with the third embodiment, with hidden features shown in phantom line;

FIG. 3(c) is a cross-sectional view of the adaptor in accordance with the third embodiment;

FIG. 3(d) is another cross-sectional view of the adaptor in accordance with the third embodiment;

FIG. 3(e) is a plan view of a first end of the adaptor in accordance with the third embodiment;

FIG. 3(f) is a plan view of an opposite second end of the adaptor in accordance with the third embodiment;

FIG. 4(a) is a perspective view of an adaptor for a trailer lift jack in accordance with a fourth embodiment of the disclosure;

FIG. 4(b) is a perspective view of the adaptor in accordance with the fourth embodiment, with hidden features shown in phantom line;

FIG. 4(c) is a cross-sectional view of the adaptor in accordance with the fourth embodiment;

FIG. 4(d) is another cross-sectional view of the adaptor in accordance with the fourth embodiment;

FIG. 4(e) is a plan view of a first end of the adaptor in accordance with the fourth embodiment;

FIG. 4(f) is a plan view of an opposite second end of the adaptor in accordance with the fourth embodiment;

FIG. 5(a) is a perspective view of an adaptor for a trailer lift jack in accordance with a fifth embodiment of the disclosure;

FIG. 5(b) is a perspective view of the adaptor in accordance with the fifth embodiment, with hidden features shown in phantom line;

FIG. 5(c) is a cross-sectional view of the adaptor in accordance with the fifth embodiment;

FIG. 5(d) is another cross-sectional view of the adaptor in accordance with the fifth embodiment;

FIG. 5(e) is a plan view of a first end of the adaptor in accordance with the fifth embodiment;

FIG. 5(f) is a plan view of an opposite second end of the adaptor in accordance with the fifth embodiment;

FIG. 6(a) is a perspective view of an adaptor for a trailer lift jack in accordance with a sixth embodiment of the disclosure;

FIG. 6(b) is a perspective view of the adaptor in accordance with the sixth embodiment, with hidden features shown in phantom line;

FIG. 6(c) is a cross-sectional view of the adaptor in accordance with the sixth embodiment;

FIG. 6(d) is another cross-sectional view of the adaptor in accordance with the sixth embodiment;

FIG. 6(e) is a plan view of a first end of the adaptor in accordance with the sixth embodiment;

FIG. 6(f) is a plan view of an opposite second end of the adaptor in accordance with the sixth embodiment;

FIG. 7 is a side view of a trailer lift jack including a crank handle mounted on an outer end of an actuator shaft of the trailer lift jack, the crank handle being in accordance with the prior art;

FIG. 8 is another side view of the trailer lift jack of FIG. 7, as viewed from behind;

FIG. 9 is a perspective view of the trailer lift jack with an adaptor in accordance with embodiments of the disclosure mounted on an outer end of an actuator shaft of the trailer lift jack;

FIG. 10 is an enlarged perspective view of the adaptor and trailer lift jack shown in FIG. 9; and

FIG. 11 is an environmental view of the adaptor and trailer lift jack of FIG. 9, illustrating a cordless drill engaged with the adaptor wherein operation of the drill actuates the actuator shaft of the trailer lift jack.

### DETAILED DESCRIPTION OF THE INVENTION

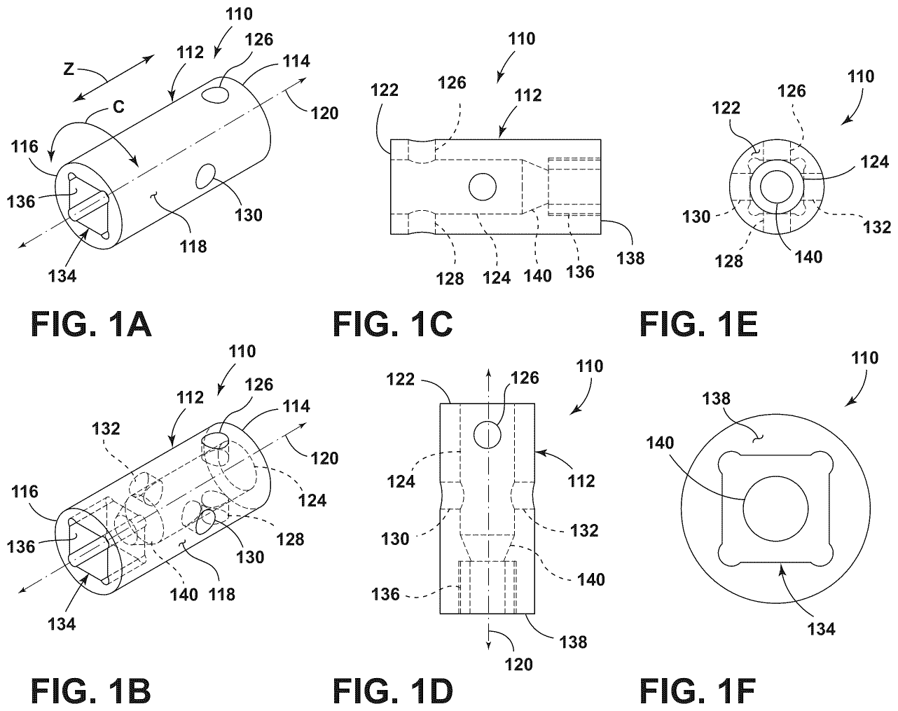

An adaptor for a trailer lift jack is provided. The adaptor can replace the handheld crank of a conventional lift jack, and can be affixed to the lift jack, either permanently or removably, by removing the handheld crank and attaching the adaptor to the trailer lift jack using a fastener such as a bolt or similar. Referring to FIGS. 1-11, wherein like numerals indicate corresponding parts throughout the several views, the adaptor for the trailer lift jack (also referred to herein as simply the lift jack) is illustrated and generally designated at 110, 210, 310, 410, 510, 610. Certain features of the adaptor 110, 210, 310, 410, 510, 610 are functional, but can be implemented in different aesthetic configurations. References to upper, lower, top, bottom, vertical, horizontal, lateral, and the like are relative to an upright disposition of the adaptor 110, 210, 310, 410, 510, 610, and are otherwise not intended to be limiting. It should be understood that the orientation of the adaptor may vary from the upright disposition, such as when manipulating the adaptor. The adaptor 110, 210, 310, 410, 510, 610 provides for quick and easy actuation of the actuator shaft of the lift jack for raising and lowering of the lift jack with minimal effort.

With reference now to FIGS. 1(a)-(f), in a first embodiment the adaptor 110 includes an elongated body 112 that extends in a longitudinal direction Z. The body 112 has a first end 114 and an opposite second end 116 that is spaced from the first end 114 in the longitudinal direction Z. A sidewall 118 extends between the first end 114 and the second end 116. The body 112 is generally cylindrical in shape. In this case, the sidewall 118 has a circular cross-section, a direction around the circumference of the circular cross-section may be referred to as a circumferential direction C, and a longitudinal axis 120 extending through the center of the cylindrical body 112 is parallel to the longitudinal direction Z. However, the body is not limited to being a cylinder and alternatively could have a square cross-section (i.e. the body may be a cuboid such as a rectangular solid), a hexagonal cross-section (i.e., the body may be a hexagonal prism), or the body may have any other elongated prismatic shape.

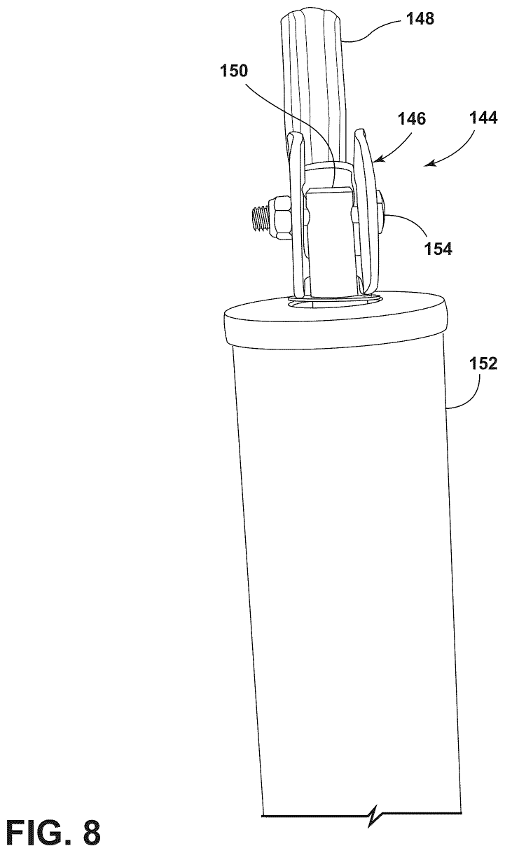

The first end 114 of the body 112 is adapted to receive an outer end of an actuator shaft of a trailer lift jack, such as the actuator shaft shown by example in FIG. 8. More particularly, the first end 114 has a first face surface 122 into which a bore 124 is formed. The bore 124 extends from the first face surface 122 into the body 112 in the longitudinal direction Z and is centered about the longitudinal axis 120. In this embodiment, the bore 124 has a circular cross-sectional shape, is generally cylindrical, and is concentric with the body about the longitudinal axis 120. The shape and section of the bore 124 matches and cooperates with the shape of the outer end of an actuator shaft of a trailer lift jack. Since the actuator shaft is typically a rod having a circular cross-section, the bore 124 also has a circular cross-section of corresponding size. However, it should be understood that if the outer end of the actuator shaft of the trailer shaft were to have a different cross-sectional shape, such as a square or hexagon, then the cross-section of the bore would also have the same square or hexagonal cross-sectional shape. Further, the length of the bore 124, and hence the length of the body 112, may be varied such that the length of the bore 124 and body 112 correspond to the length of the outer end portion of the actuator shaft as described in more detail below.

At least one pair of openings are formed in the sidewall 118 of the body 112. In the first embodiment, the adaptor 110 includes a first pair of openings 126, 128 and a second pair of openings 130, 132. Each opening 126, 128, 130, 132 extends from the outer surface of the sidewall 118 to the bore 124 such that the openings 126, 128, 130, 132 are connected to the bore 124. Each opening 126, 128, 130, 132 has a circular cross-sectional shape and extends in a direction that is transverse to and perpendicular to the longitudinal direction Z. Hence, the openings 126, 128, 130, 132 are also perpendicular to the longitudinal axis 120 of the body 112. The openings 126, 128 of the first pair are disposed 180 degrees apart from each other radially around the sidewall 118 in the circumferential direction C. Hence, the openings 126, 128 are aligned with each other along a line that runs through and is perpendicular to the longitudinal axis 120 of the body 112. Likewise, the openings 130, 132 of the second pair are disposed 180 degrees apart from each other radially around the sidewall 118 in the circumferential direction C. Hence, the openings 130, 132 are also aligned with each other along a line that runs through and is perpendicular to the longitudinal axis 120 of the body 112. Further, the first pair of openings 126, 128 is offset from the second pair of openings 130, 132 in the longitudinal direction X such that the first pair of openings 126, 128 are closer to the first end 114 of the body 112 than the second pair of openings 130, 132. Also, the first pair of openings 126, 128 is offset from the second pair of openings 130, 132 in the circumferential direction C. For example, as shown the first pair of openings 126, 128 are offset from the second pair of openings 130, 132 90 degrees radially around the sidewall 118 in the circumferential direction C. However, it should be understood that the radial offset between the pairs of openings is not limited to 90 degrees and may be any angular amount between 0 and 90 degrees, or the pairs of openings may not be offset in the circumferential direction (i.e., 0 degrees). Each pair of openings 126, 128 and 130, 132 provide for the securing of the adaptor 110 to a lift jack actuator shaft as described in more detail below.

The second end 116 of the body 112 is adapted to mate with a drive such as but not limited to the male portion/member of a ½ inch square drive. More specifically, the second end 116 includes a receiver 134 that is the female portion of a square connection fitting which receives the square male portion. As such, the receiver 134 includes a recess 136 that extends from a second face surface 138 into the body 112. The recess 136 of the receiver 134 generally has a square cross-sectional shape, and as shown, may have rounded or curved corners. The size and shape of the receiver 134 is made to match the size and shape of the corresponding male portion of the drive. Thus, for example, the receiver 134 may be sized to receive the male portion of a ½ inch square drive. It should be understood that the adaptor is not limited to use with a particular sized drive (e.g., ½ inch square drive described above) and may operated with a different sized drill such as, for example, a ⅜ inch drive or a ¼ inch drive. As such, the receiver 134 is not particularly limited in its size and may be sized to receive drives other than a ½ inch square drive.

The bore 124 may include a taper 140 at an inner end of the bore (opposite the outer end at the first face surface 122). The taper 140 is connected to the receiver 134 such that there is a continuous passage through the bore 124 from the first end 114 to the second end 116.

The body 112 is preferably formed of a metal such as but not limited to steel or a steel alloy including but not limited to a chromium-vanadium steel alloy, a chromium-molybdenum steel alloy, or stainless steel. Alternatively, the body 112 may be formed of a hard, non-elastic polymer material.

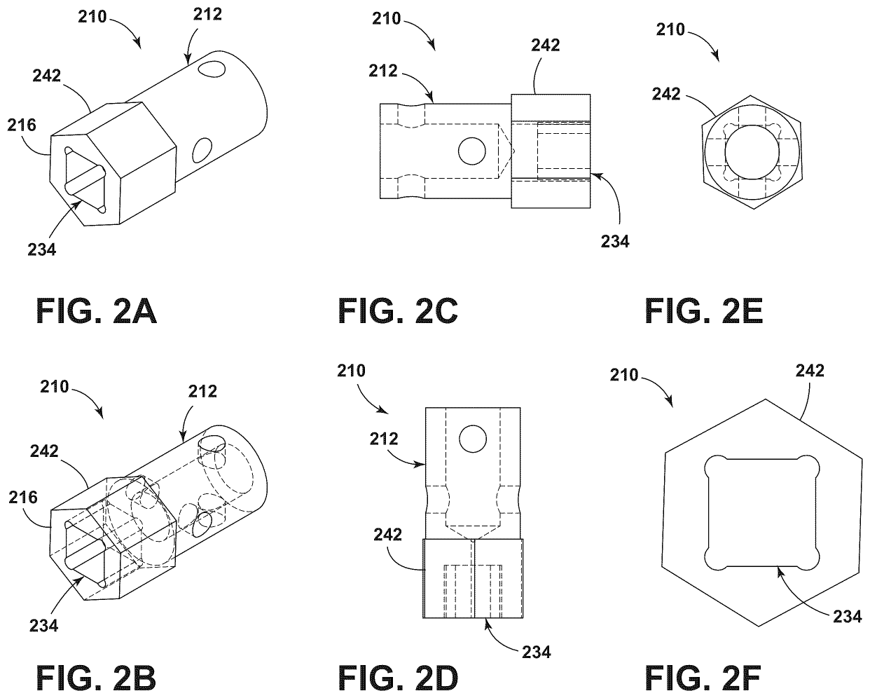

Turning now to FIGS. 2(a)-(f), in a second embodiment the adaptor 210 further includes a head 242 at the second end 216 of the body 212. The head 242 generally surrounds the inner sides of the receiver 234. The head 242 is configured to mate with a socket of a wrench. As such, the cross-sectional shape of the head 242 is a hexagon. Sockets that can mate with a hexagonal head are well-known and will not be described in greater detail. The head 242 of the body 212 allows for dual driving of the adaptor 210, either via a square drive using the receiver 234 or by a wrench socket using the head 242 as discussed in more detail below. It should be understood that the head 242 is not limited to a particular size (for mating with a socket), and as such the head 242 may be sized to mate with any size socket, including but not limited to a ¾ inch socket, a ⅞ inch socket, a 15/16 inch socket, or an equivalent millimeter-sized socket such as a 29 mm socket. Other than the element of the head 242, the adaptor 210 has the same structure as the adaptor 110.

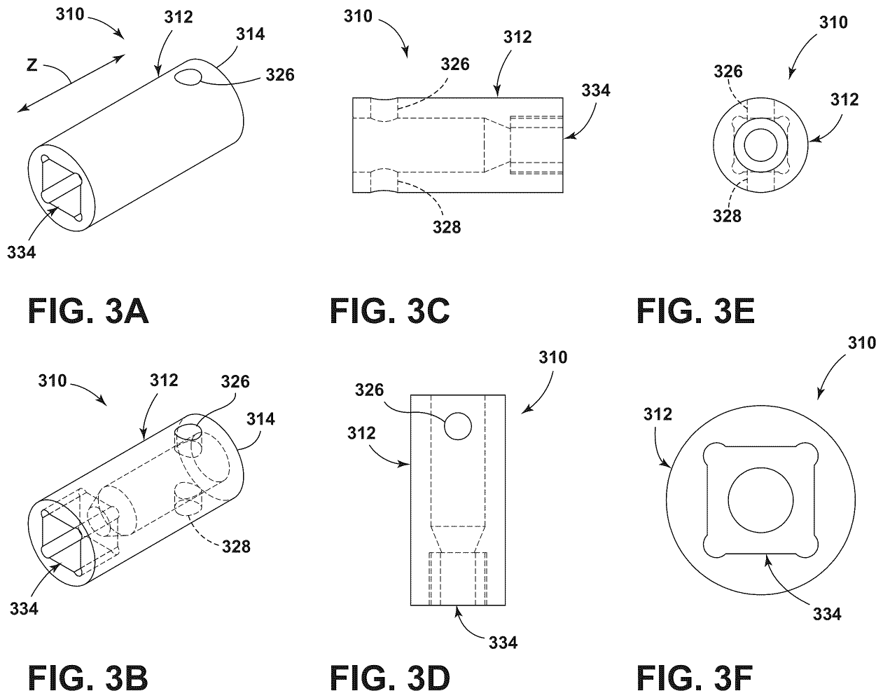

Turning next to FIGS. 3(a)-(f), in a third embodiment the adaptor 310 only has one pair of openings, particularly the first pair of openings 326, 328 that are closer to the first end 314 of the body 312. However, it should be understood that the pair of openings 326, 328 generally may be positioned anywhere in the longitudinal direction Z between the first end 314 of the body 312 and the receiver 334. The adaptor 310 otherwise has the same structure as the adaptor 110.

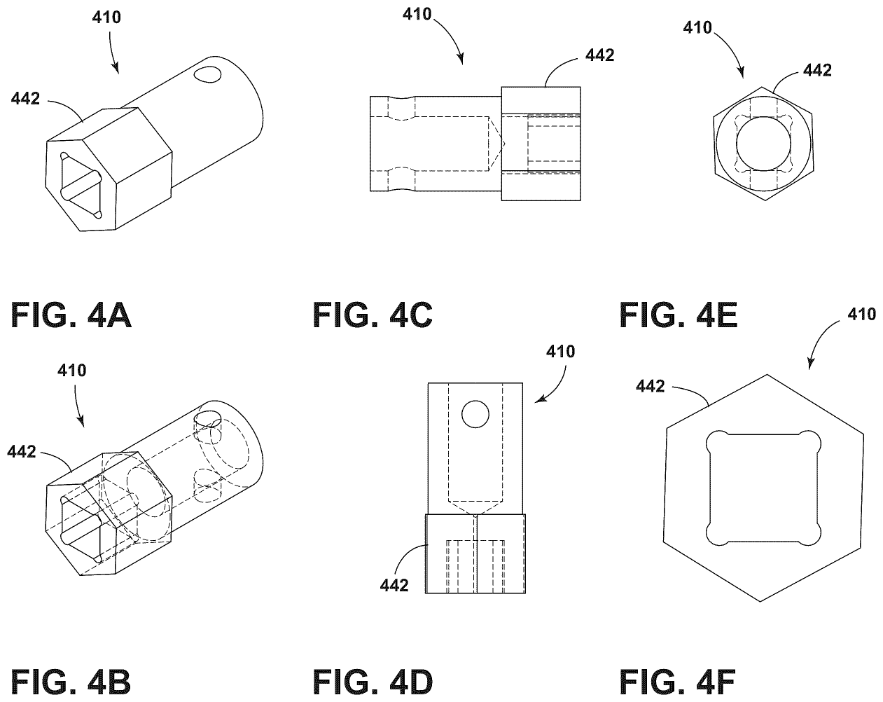

Turning next to FIGS. 4(a)-(f), in a fourth embodiment the adaptor 410 is the same as the adaptor 310 but further includes a head 442 in the same manner as the second embodiment 210.

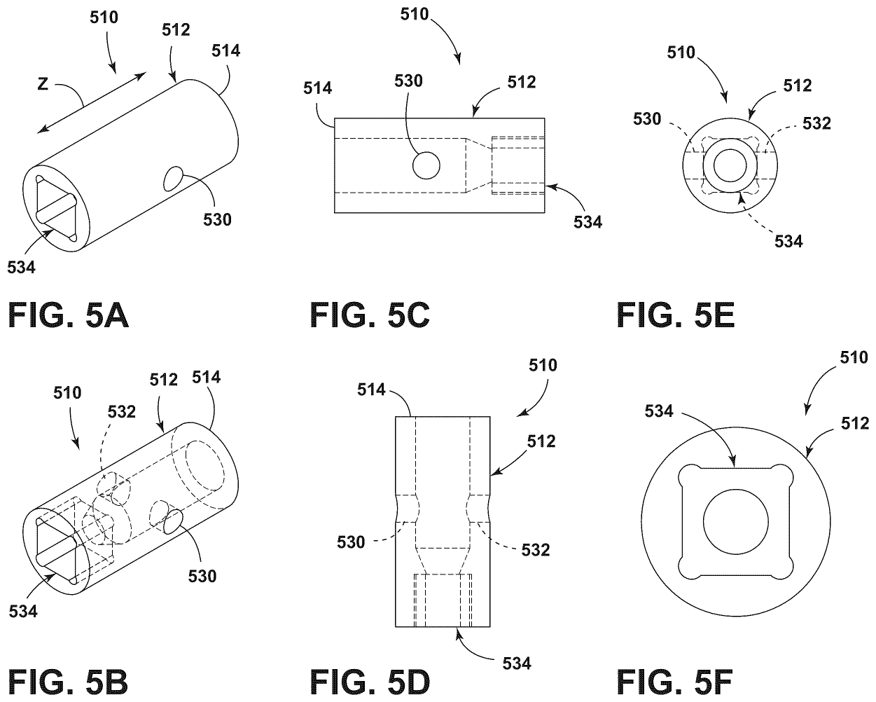

Turning next to FIGS. 5(a)-(f), in a fifth embodiment the adaptor 510 only has one pair of openings, particularly the second pair of openings 530, 532 that are farther from the first end 514 of the body 512. However, it should be understood that the pair of openings 530, 532 generally may be positioned anywhere in the longitudinal direction Z between the first end 514 of the body 512 and the receiver 534. The adaptor 510 otherwise has the same structure as the adaptor 110.

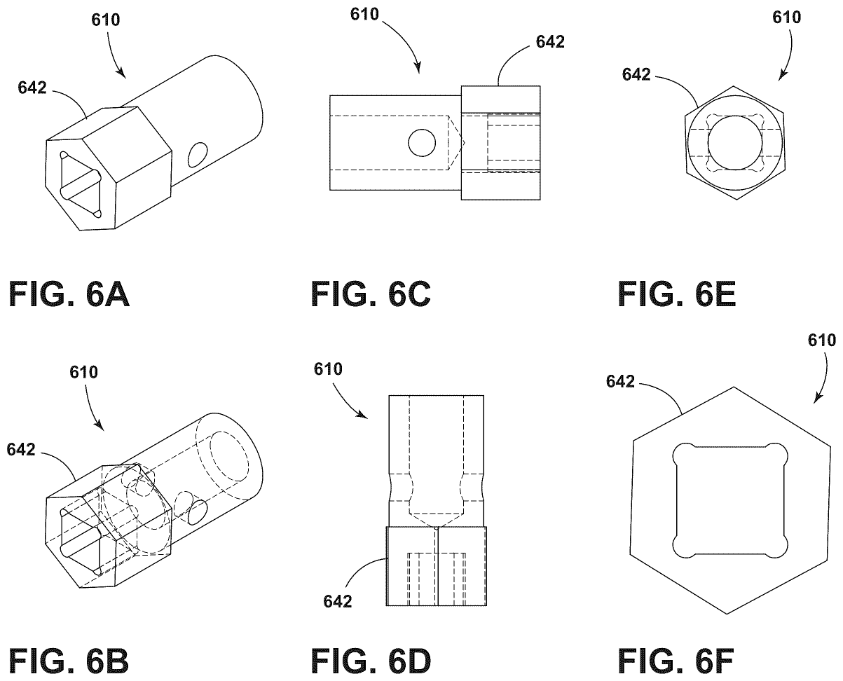

Turning next to FIGS. 6(a)-(f), in a sixth embodiment the adaptor 610 is the same as the adaptor 510 but further includes a head 642 in the same manner as the second and fourth embodiments 210, 410.

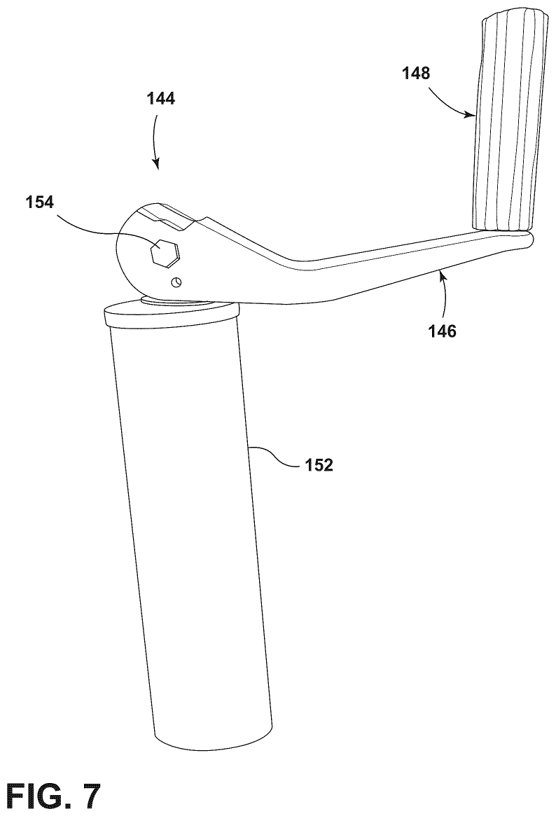

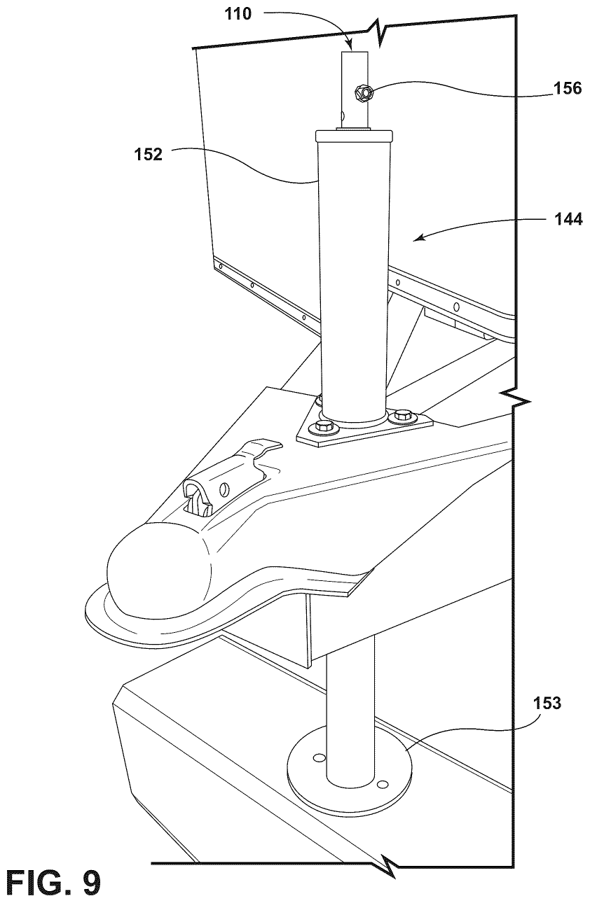

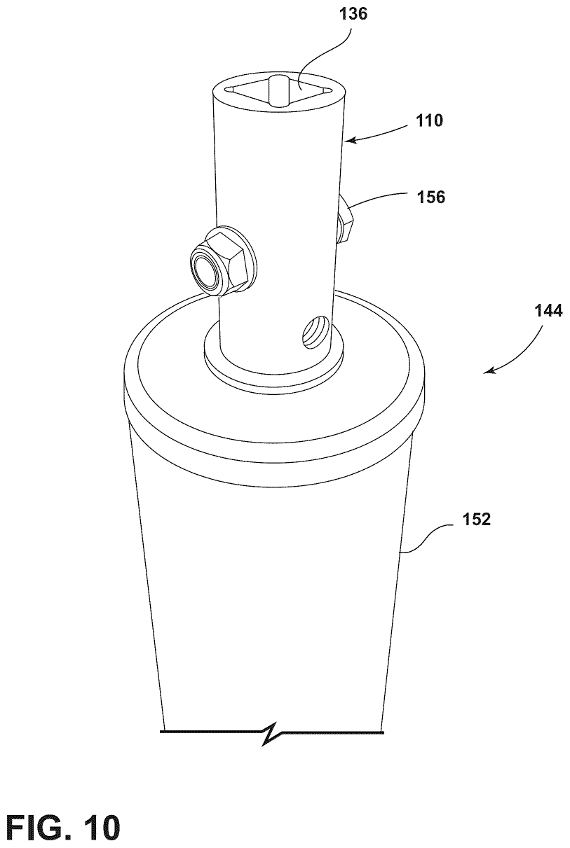

With reference now to FIGS. 7-11, the adaptor 110 can be installed on and used with a trailer lift jack as follows. As shown in FIGS. 7 and 8, a trailer lift jack 144 conventionally has a hand crank 146 that includes a crank handle 148 mounted on an outer end of an actuator shaft 150 that extends outwardly from the top (or side) of the lift jack cylinder 152. Cranking of the crank handle 146 rotates the actuator shaft 150 which in turn extends or retracts a support foot, wheel, or similar at the end of the shaft to raise or lower the lift jack, depending on the cranking direction (clockwise or counterclockwise). A support foot 153 is shown in FIG. 9. The hand crank 146 is commonly mounted on the actuator shaft 150 by a fastener 154 (e.g., nut and bolt) that extends through hole(s) in the crank handle 146 and a corresponding opening such as an eye hole through the actuator shaft as can best by seen in FIG. 8 and also viewed from the side in FIG. 7. To install the adaptor 110, the crank handle 146 is unfastened by unscrewing the nut from the bolt and removing the bolt to release the crank handle from the actuator shaft 150. Next, the adaptor 110 is placed over and on top of the outer end of the actuator shaft 150 by sliding the adaptor onto the actuator shaft such that the actuator shaft is inserted into the bore 124 and the adaptor 110 rests on the actuator shaft 150 and/or cylinder 152 of the lift jack 144 as shown in FIGS. 9 and 10. The position of the openings 126, 128 or the openings 130, 132 are set such that when the adaptor 110 is placed on the actuator shaft 150, at least one set of the openings 126, 128 or 130, 132 are aligned with the eye hole in the actuator shaft from which the crank handle 146 was removed. The adaptor 110 has multiple pairs of openings to accommodate different actuator shaft lengths and eye hole positions, although the adaptor need only have one pair of openings. Further, the length of the body 112 of the adaptor 110 is designed such that the actuator shaft 150 of the lift jack 144 may sufficiently extend into the bore 124 to align the openings in the adaptor with the eye hole in the actuator shaft 150, and preferably so that when the adaptor 110 is placed on the actuator shaft 150, the adaptor 110 may completely cover the actuator shaft 150 while also allowing at least one set of the adaptor openings to align with the eye hole in the actuator shaft. Typically, in this orientation, the adaptor 110 will also contact the top of the lift jack cylinder 144 as shown for example in FIGS. 9 and 10. Once a pair of the openings 126, 128 or 130, 132 are aligned with the eye hole of the actuator shaft 150, a fastener 156 is inserted through the pair of openings and the aligned eye hole of the actuator shaft 150 to secure and fix the adaptor 110 to the actuator shaft 150, as shown in close detail in FIG. 10. As shown, the fastener 156 may be a bolt that is secured with a nut (and optionally a washer on the bolt adjacent the nut). Alternatively, the fastener may be a bolt or pin such as a clevis pin that is secured with a cotter pin, a hair pin, or similar, or the fastener may be a self-locking pin such as a quick-release pin or other type of cotterless pin. The fastener is not particularly limited, so long as it is capable of releasably fixing the adaptor 110 to the actuator shaft 150.

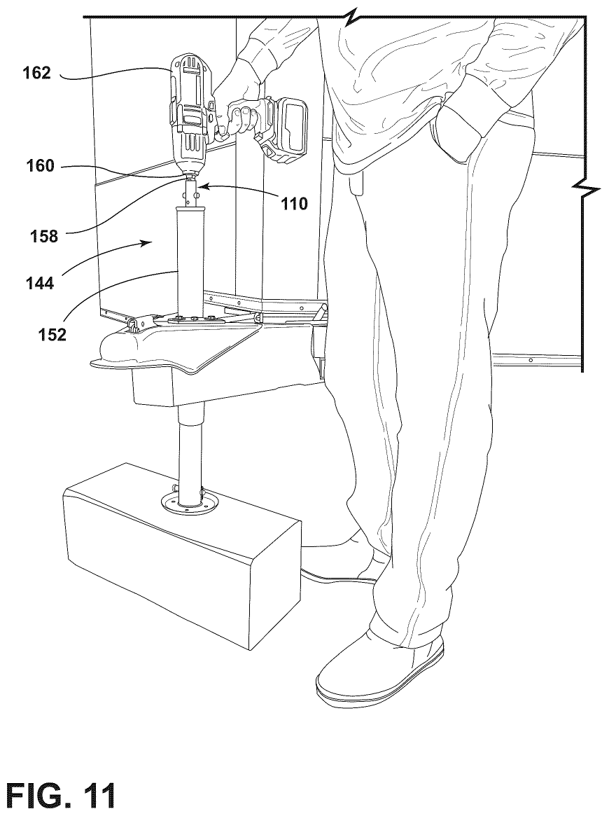

Turning now to FIG. 11, once the adaptor 110 is secured onto the actuator shaft 150, a drive member is inserted into the receiver 134 that is positioned at the top or outer end of the adaptor 110 when the adaptor is in the mounted disposition. For example, as shown in the drawings, a ½ inch driver bit 158 can be secured into the chuck 160 of a power tool 162 such as a cordless drill, a cordless impact driver, a drill with an electrical cord, and the like. A cordless power drill is shown in the drawings. The power drill 162 is manipulated to insert the ½ drive male drive member at the end of the bit 158 into the recess 136 of the receiver. Triggering of the power drive 162 rotates the adaptor 110 which in turn actuates the actuator shaft 150 to quickly and easily extend or retract the lift jack 144 depending on the rotational direction set for the power drill 162. In the embodiments 210, 410, 610 of the adaptor, a wrench socket may be secured to the ½ inch driver bit in the power drill, and the wrench socket can be mated with the hexagonal head 242, 442, 642. Triggering of the drill rotates the adaptor via the mated connection between the socket and the hexagonal head. Hence, in these embodiments 242, 442, 642 the adaptor 210, 410, 610 has a dual-drive capability.

While the adaptor is preferably driven by a power drill, it should be understood that if a power drill is not physically available, or for example, in a case in which the battery pack of the power drill has an insufficient electrical charge, the adaptor may be driven by hand. For example, a handheld tool such as a ratcheting socket wrench or similar socket wrench, a breaker bar, or similar that includes a square drive may be mated with the receiver of the adaptor. The handheld tool may also be a tool that is specially designed to be used with the adaptor, and such a specially designed handheld tool may include a drive bit or socket sized to mate with the adaptor as described above. Manual rotation of the handheld tool actuates the actuator shaft, and depending on the size of the tool, may require less effort than cranking of the conventional crank handle of the lift jack. Further, in the embodiments 210, 410, 610, a socket may be mounted onto the handheld tool, and the socket can optionally be mated with the hexagonal head 242, 442, 642 in the same manner as described above.

It is to be understood that the appended claims are not limited to express and particular structures, compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. An adaptor for a trailer lift jack, the adaptor comprising:
an elongated body extending in a longitudinal direction, the body having first and second opposite ends spaced from each other in the longitudinal direction, and a sidewall extending between the first and second ends, the first end being adapted to receive an actuator shaft of a trailer lift jack and the second end being adapted to mate with a drive;
the first end including a bore extending into the body in the longitudinal direction;
at least one pair of openings in the sidewall, the openings of each pair extending from the sidewall to the bore, and the openings of each pair being aligned with each other;
wherein the adaptor is disposable over an outer end of the actuator shaft of the trailer lift jack such that the outer end of the actuator shaft is received into the bore, and the adaptor is secured to the actuator shaft by a fastener extending through one said pair of openings and a corresponding opening through the actuator shaft.

2. The adaptor of claim 1, wherein the openings are transverse to the longitudinal direction.

3. The adaptor of claim 1, wherein the openings are perpendicular to the longitudinal direction.

4. The adaptor of claim 1, wherein the openings of each pair are disposed 180 degrees apart from each other radially around the sidewall.

5. The adaptor of claim 1, including two pairs of said openings.

6. The adaptor of claim 5, wherein one said pair of openings is offset from the other said pair in the longitudinal direction.

7. The adaptor of claim 5, wherein one said pair of openings is offset from the other said pair in a circumferential direction.

8. The adaptor of claim 1, wherein each said opening has a circular cross-sectional shape.

9. The adaptor of claim 1, wherein the body is cylindrical in shape.

10. The adaptor of claim 1, wherein the bore has a circular cross-sectional shape.

11. The adaptor of claim 1, wherein the bore is centered along a longitudinal axis of the body that extends in the longitudinal direction.

12. The adaptor of claim 1, wherein the second end includes a receiver for receiving a male portion of a square drive.

13. The adaptor of claim 12, wherein the bore includes a taper at an inner end of the bore, the taper being connected to the receiver.

14. The adaptor of claim 1, wherein the second end of the body includes a head configured to mate with a wrench socket.

15. The adaptor of claim 14, wherein the head has a hexagonal cross-sectional shape.

16. A system for driving an actuator shaft of a trailer lift jack, the system comprising:
the adaptor of claim 1;
a fastener; and
a drive;
wherein the adaptor is disposed over an outer end of the actuator shaft of the trailer lift jack such that the outer end of the actuator shaft is inserted into the bore;
wherein the fastener is inserted through one said pair of openings and a corresponding opening through the actuator shaft, the corresponding opening in the actuator shaft being aligned with the one said pair of openings;
wherein the second end of the adaptor includes a receiver for receiving the drive, and the drive is mateable with the receiver, and operation of the drive actuates the actuator shaft.

17. The system of claim 16, wherein the fastener is one of a bolt and a pin.

18. The system of claim 16, wherein the drive is one of a drill and a wrench.

19. A method of driving an actuator shaft of a trailer lift jack, the method comprising the steps of:
providing the adaptor of claim 1, the adaptor further including a receiver for receiving a drive member;
disposing the adaptor over an outer end of the actuator shaft of the trailer lift jack such that the outer end of the actuator shaft is inserted into the bore;
inserting a fastener through one said pair of openings and a corresponding opening through the actuator shaft, the corresponding opening in the actuator shaft being aligned with the one said pair of openings;
mating the drive member with the receiver; and
operating the drive to actuate the actuator shaft of the trailer lift jack.
